(19) United States
(12) Patent Application Publication
(10) Pub. No.: US 2021/0298879 A1
(43) Pub. Date: Sep. 30, 2021

(54) METHOD OF MANUFACTURING A DENTAL COMPONENT

(71) Applicant: REDIOS-TEC GMBH, Freilassing (DE)

(72) Inventor: Stephan Miller, Traunstein (DE)

(21) Appl. No.: 17/265,501

(22) PCT Filed: Jun. 28, 2019
(86) PCT No.: PCT/EP2019/067343

§ 371 Date: May 24, 2021

(30) Foreign Application Priority Data
Aug. 6, 2018 (DE) 10 2018 119 080.8

(51) Int. Cl. A61C 13/00; A61C 13/08; A61C 13/20

(52) U.S. Cl. CPC A61C 13/0004; A61C 13/0019; A61C 13/20; A61C 13/081

(57) ABSTRACT

The present invention relates to a method of manufacturing a dental component, in particular a dental prosthesis or a partial dental prosthesis, by means of a dental furnace, comprising the following steps:
(i) preparing a virtual model of the dental component;
(ii) automatically selecting one, two or more programs and/or automatically preparing one, two or more programs and/or preparing one, two or more suggestions for a program for operating the dental furnace on the basis of the virtual model of the dental component;
(iii) producing a model of the dental component;
(iv) embedding the model in an investment material;
(v) removing the model from the investment material, in particular by heating or burning out, to obtain a negative mold of the model;
(vi) inserting a raw material required for manufacturing the dental component into the negative mold; and
(vii) producing the dental component in the negative mold in the dental furnace on the basis of the selected, prepared, or suggested program.

The present invention relates to a method of manufacturing at least one dental component, in particular a dental prosthesis or a partial dental prosthesis, by means of a dental furnace.

Methods of manufacturing dental components are generally known and usually comprise a plurality of complex individual steps that are performed manually for the most part. In a first step, a dental impression of the respective patient is prepared. The model for the dental component to be produced can subsequently be produced with the aid of this dental impression. For this purpose, the model is, for example, molded by hand using a—still unprocessed—wax blank. The wax blank can be characterized by a size adapted to the dental impression, wherein the wax blank is also processed in a complex manner and is individually adapted to the dentition of the patient. However, it is also possible to select an already molded wax blank—at least approximately suitable for the conditions present with the impression—that only has to be modified slightly or not at all. The finished model of the dental component is subsequently positioned by hand on a base body, a so-called column, to produce a so-called abutment. The column is composed of a material that has similar properties to the material of the model at least with respect to the melting behavior. The model is embedded together with the column in an investment material. As soon as the investment material has been cured, the model and the column are burnt out of the investment material. For this purpose, the cured investment material is positioned in a furnace such that the melted model material can flow out of the investment material. The result of the process is a negative mold of the model and of the column—that is of the abutment—in the investment material.

The negative mold is subsequently filled with a raw material of which the dental component is to be composed. The raw material is present in pellet form, for example. It is inserted into the channel of the negative mold formed by the column. The raw material is melted within the negative mold by a suitable process and using a corresponding apparatus and is—at least temporarily—acted on by a pressing force. After the curing of the component, the negative mold subsequently has to be removed carefully and usually in a very complex manner to expose the finished dental component in an undamaged manner.

The production of the dental component is thus associated with a very high work effort. In addition, due to the large number of required individual steps for producing the dental component, defects can occur at many points and defects can be carried away.

It is therefore an object of the present invention to provide a method of manufacturing a dental component and a corresponding system that is characterized by a lower work effort. In addition, the possible error sources should be minimized.

This object is satisfied by a method having the features of claim 1 and by a system having the features of claim 13.

The method comprises the following steps:
(i) preparing a virtual model of the dental component;
(ii) automatically selecting one, two or more programs and/or automatically preparing one, two or more programs and/or preparing one, two or more suggestions for a program for operating the dental furnace on the basis of the virtual model of the dental component;
(iii) producing a model of the dental component;
(iv) embedding the model in an investment material;
(iv) removing the model from the investment material, in particular by heating or burning out, to obtain a negative mold of the model;
(v) inserting a raw material required for manufacturing the dental component into the negative mold; and
(vi) producing the dental component in the negative mold in the dental furnace on the basis of the selected, prepared, or suggested program.

Therefore, the method in accordance with the invention is characterized in that a virtual model of the dental component is prepared. A program that controls and/or regulates the operation of the furnace is prepared or selected automatically—i.e. without an intervention by an operator—on the basis of the virtual model. The program can be used directly or it is suggested to the operator who must authorize the use of the program. It is also conceivable that the program suggested can be modified by the operator before it is started.

The type and/or the properties of the raw material used can be taken into account when preparing and/or selecting the firing program. It is e.g. possible for the operator to input corresponding information manually and/or to obtain it from a database and to integrate it into the virtual model when planning the latter.

Since the virtual model is known, the volume and/or the geometry of the dental component and/or other characteristic parameters of the dental component can be taken into account when selecting or preparing the program controlling/regulating the furnace to ensure ideal firing results and also to take economic aspects into account at the same time. A taking into account of the properties of the dental component to be produced, for example, makes it possible to generate or select a firing program that lasts as long as necessary, but as short as possible.

The data of the virtual model are used to select a suitable program from a program library stored in the furnace or from a program library stored in an external database. It is likewise possible that a program taken from a library is adapted or modified while taking into account the virtual model or that an individual program is created on the basis of the virtual model. For example, characteristic parameters of the virtual model are fed into suitable algorithms for this purpose. A suitable program, for example, comprises at least one constant or time-variable operating parameter, in particular a plurality of constant or time-variable operating parameters, of the furnace and/or functions of the operating parameter or parameters in dependence on the time.

For the manufacture of a dental component, a model is—as already mentioned—required on the basis of which a negative mold of the desired dental component is prepared. For example, the model is produced from a wax-like blank. Different methods can be selected for producing the model. The model can, for example, be taken from a collection of preformed blanks and can be modified as required. The preformed blanks can be manufactured in large quantities and can cover different sizes. The blanks can both already be ready-to-use and adjustable. It is likewise possible for the model to be individually produced, in particular on the basis of the virtual model.

Depending on the production type, it is also conceivable that the virtual model of the dental component is prepared during the production of the model. It is also possible that the virtual model is prepared after the production of the model. The model produced can in this respect in particular be scanned to obtain a virtual model. In other words, step (iii) is performed before steps (i) and (ii) in this embodiment of the method.

The model produced is embedded in an investment material. Some already known methods can be selected for the embedding.

To obtain a negative mold of the model, the model is removed from the investment material. The model and the base body are preferably melted by an elevated temperature. The melted material can, for example, flow off through a suitable channel.

The raw material is subsequently inserted into the negative mold to produce the dental component. It is particularly advantageous if the aforementioned channel is used in this respect to remove the model material.

The negative mold with the inserted raw material is heated in the furnace. The operating program for the furnace is—as already mentioned—selected or prepared (in particular automatically or semi-automatically) on the basis of the virtual model.

Following the curing of the raw material after the firing process, the dental component produced is present in the negative mold.

Advantageous embodiments of the invention are also set forth in the claims, in the following description, and in the Figures.

In accordance with an embodiment, step (ii) comprises automatically selecting at least two programs and/or automatically preparing at least two programs and/or preparing at least two suggestions for a program for operating the dental furnace on the basis of the virtual model of the dental component, with a user manually selecting one of the at least two programs so that it is used in step (vii). The program selection/preparation is therefore not carried out completely automatically here, but the user is “offered” two or more programs from which he selects the one he considers most suitable for the specific case. This program is then used to produce the component. Provision can be made that this program can also be edited by the user in order, for example, to take particular situations into account.

In accordance with a further embodiment, at least one process parameter for removing the model from the investment material is automatically selected and/or generated and/or suggested on the basis of the virtual model of the dental component, in particular a burnout temperature, a burnout duration, and/or a temporal progression of the burnout temperature. This at least one parameter can be modified by the operator as required. The type and/or the properties of the material from which the model is produced can also be taken into account when selecting or generating or suggesting the process parameter. This information is preferably integrated into the virtual model so that it can be taken into account automatically.

By adjusting the burnout temperature, the burnout duration, and/or the temporal progression of the burnout temperature, the burnout furnace used for the burnout can be used efficiently. It can be ensured that the model is really completely removed from the negative mold. In addition, the furnace does not have to be operated at a higher temperature or for a longer time than necessary, whereby not only is energy saved, but the investment material is additionally protected from an unnecessarily strong heat influence.

In accordance with a further embodiment, the production of the dental component takes place on the application of a pressing force, in particular on the application of a pressing force of 10 N to 1000 N, and/or takes place in a temperature range from 100° C. to 1200° C. A firing of the dental component under a constant or time-variable application of pressing force provides particularly good results, among other things, also because a complete and uniform filling of the negative mold by the raw material is thereby achieved, on the one hand. On the other hand, the formation of pores within the dental component is kept as low as possible.

In accordance with a further embodiment, the program for operating the dental furnace comprises at least one parameter (preferably a plurality of constant or time-variable parameters) that represents a firing temperature, a firing duration, a temporal progression of the firing temperature, a pressing force, a temporal progression of the pressing force, a cooling temperature, a cooling duration, and/or a temporal progression of the cooling temperature.

In a further embodiment, the at least one parameter and/or the at least one process parameter is/are determined on the basis of the virtual model and/or is/are taken from a database.

Provision can be made that at least a portion of data required for the preparation of the virtual model is acquired by intraorally scanning a dentition of a patient or a part thereof; and/or that at least a portion of data required for the preparation of the virtual model is acquired by scanning a negative impression of a dentition of a patient or a part thereof; and/or that at least a portion of data required for the preparation of the virtual model is taken from a database.

The model of the dental component is preferably additively manufactured from a model material on the basis of the virtual model of the dental component in an automatic manner or with only minimal operator interventions, in particular by means of 3D printing. A suitable process is e.g. stereolithography (e.g. laser microstereolithography). The model material is then in particular a light-curing plastic that is initially present in the form of liquid base monomers. Local photopolymerization events are effected layer by layer by means of laser beams and together produce the desired structure.

The process can be further automated by additive manufacturing. A human error in the processing of the model is hereby reduced. In addition, fine details in the structure of the dental component can be produced in a reproducible manner with the aid of additive manufacturing, which is only possible to a limited extent in a production of the model by hand.

In addition, considerable costs can be saved by producing the model by means of additive manufacturing, or 3D printing, since, on the one hand, no storage or holding costs for model blanks are incurred and, on the other hand, material costs can be saved since additive manufacturing—as the name already suggests—is a build-up process and excess material therefore does not have to be removed and disposed of by means of a stripping process, as is the case with a reworking of a model blank.

If provision is made to print a plurality of models at the same time, they can be arranged in the virtual model such that an optimized and efficient additive manufacturing of all the models together is possible. This optimized arrangement can be automatically calculated on the basis of the virtual models.

In accordance with a further embodiment, the model is connected to at least one base body that is in particular produced from the model material and that forms a channel in the negative mold, in which channel a pressing tool, in particular a punch for a pressing process, can be guided and/or through which channel the raw material can be fed to the negative mold. The channel can also serve for the removal of the model material.

Due to a suitable design of the channel, for example as a straight-line channel with a circular cross-section, the pressing tool (e.g. a cylindrical punch) can be moved in a guided manner.

Furthermore, the feeding of the raw material is simplified by the channel. The raw material can thereby not only be introduced in a liquid or powdered state; it is likewise possible for the raw material to be present in pellet form, for example. The diameter or the dimensions of the raw material pellets can be adapted to the size or the diameter of the channel. For example, the diameters of the pellets used, of the channel, and of the pressing punch are substantially the same to enable the best possible pressing force transmission. Ideally, the pellets were each adapted to the raw material requirements of a specific dental component.

Provision can furthermore be made that the base body and—if present—a connection passage connecting the base body and the model are integrally produced with the model by means of the additive manufacturing process; or that the model is fastened to the base body before the embedding, in particular with the aid of the model material, preferably while forming a connection passage connecting the base body and the model. Due to the integral production, the work step of attaching the model to the base body can be saved. The connection passage is ultimately a kind of web for the model that forms a passage in the negative mold.

In accordance with a further embodiment, a first and at least a second dental component are simultaneously manufactured, with a first and a second model being jointly embedded in the investment material, and with their spatial arrangement in the investment material—and, if provided, their additive manufacturing—being automatically planned and/or suggested on the basis of the virtual model of the first and second dental components.

The first and second models or the further models are preferably additively manufactured together.

In accordance with a further embodiment, after the step of the production, the dental component is deflasked in an at least partly automated manner by removing the negative mold on the basis of a virtual model of the dental component, in particular by means of a stripping manufacturing process such as compressed air blasting, and/or water blasting, and/or milling.

The automated deflasking can in particular be designed such that a removal speed is adapted to the position of the produced dental component within the investment material. For example, the further away the dental component is from the current removal position, the higher the removal speed is selected. The removal speed decreases accordingly in the vicinity of the dental component. A gentle and nevertheless efficient deflasking of the dental component is hereby made possible.

To accelerate the deflasking, a total segment of the investment material, with respect to which it is known based on the virtual model that no dental component is included therein, can be cut off.

It is likewise conceivable that a portion of the investment material is manually removed. In this respect, it is particularly preferred if a portion of the investment material is removed that is the furthest away from the dental component produced. After the manual removal of a portion of the investment material, the remaining investment material is removed in an automated manner. It is self-explanatory that the manual removal and the automated removal can also be swapped so that the portion of the investment material removed from the dental component produced is first removed in an automated manner and the dental component is then manually deflasked.

A system in accordance with the invention for manufacturing a dental component, in particular a dental prosthesis or a partial dental prosthesis, comprises a programmable dental furnace; and a control and regulation device (designated only as a control device in the following) that is configured and adapted to automatically select at least one program for operating the dental furnace and/or to automatically prepare at least one such program and/or to automatically suggest at least one such program on the basis of a virtual model of the dental component, in particular with the control device being configured and adapted to directly or indirectly control the dental furnace.

The dental furnace preferably has a pressing device by means of which the raw material can be inserted into the negative mold on the application of a pressing force and/or by means of which the dental component can be produced on the application of a pressing force. In principle, the total firing process or at least parts thereof can take place on the application of a pressing force.

In accordance with a possible embodiment of the system, the system additionally comprises a raw data acquisition device, in particular an optical scanner, for intraorally scanning a dentition of a patient or a part thereof and/or for scanning a negative impression of a dentition of a patient or a part thereof and/or for scanning a model of the dental component.

In accordance with a further embodiment of the system, the control device is configured and adapted to receive the virtual model and/or to prepare the virtual model on the basis of data of at least one scan.

The system preferably additionally comprises a model manufacturing apparatus for the additive manufacturing of the model on the basis of the virtual model, in particular with the model manufacturing apparatus being connectable or connected to the control device to receive control data from the control device. Alternatively, the control data can also be generated in the model manufacturing apparatus on the basis of the data of the virtual model. The model manufacturing apparatus can be an apparatus for stereolithography.

In accordance with a further embodiment of the system, the system additionally comprises a programmable furnace for removing the model from the investment material, with the furnace being connectable or connected to the control device to receive control data from the control device, in particular with the control device being configured and adapted to automatically select at least one process parameter for operating the furnace and/or to automatically prepare such a process parameter and/or to automatically suggest such a process parameter on the basis of a virtual model of the dental component.

In accordance with a further embodiment, the system additionally comprises a deflasking device for an at least partly automated removal of the dental component from the negative mold on the basis of a virtual model, with the deflasking device being connectable or connected to the control device to receive control data from the control device, in particular with the deflasking device working by means of a stripping manufacturing process such as compressed air blasting, and/or water blasting, and/or milling.

In accordance with yet a further embodiment, the scanning apparatus and/or the model manufacturing apparatus and/or the programmable furnace and/or the dental furnace and/or the deflasking device has/have a control unit that is separate from the control device and that is connectable and/or connected to the control device, in particular with the control device providing a higher-ranking control.

The method in accordance with the invention and the system in accordance with the invention will be described purely by way of example in the following with respect to an advantageous embodiment and to the Figures enclosed. There are shown:

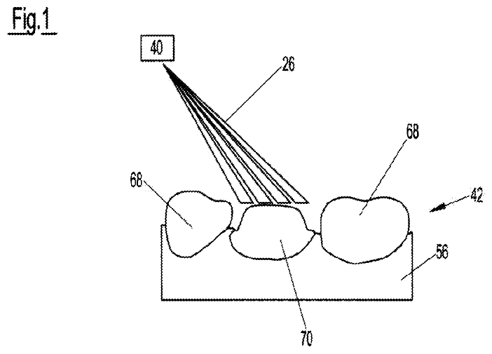

FIG. 1 an intraoral scanning of a dentition of a patient;

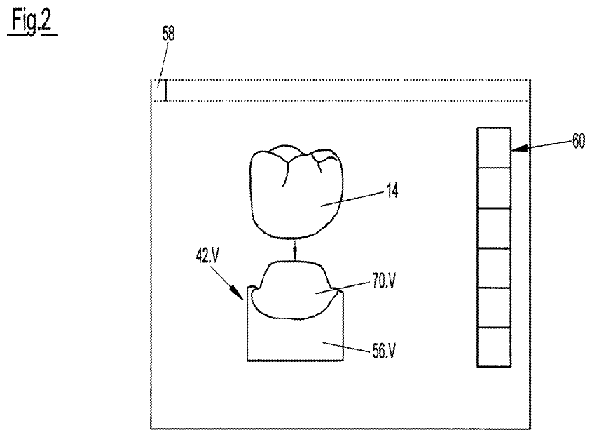

FIG. 2 a preparation of a virtual model of a dental component adapted to the dentition of the patient with the aid of a computer-based program;

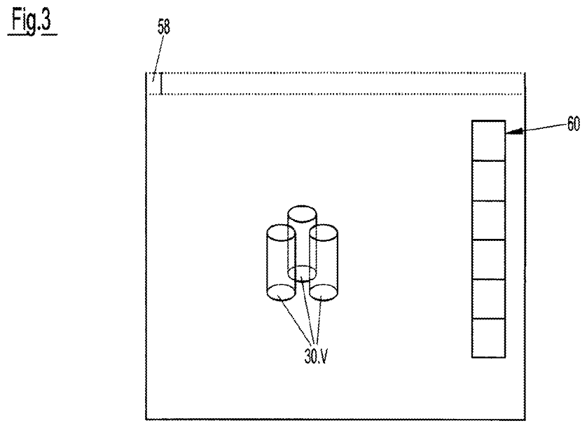

FIG. 3 a positioning of virtual base bodies with the aid of the program;

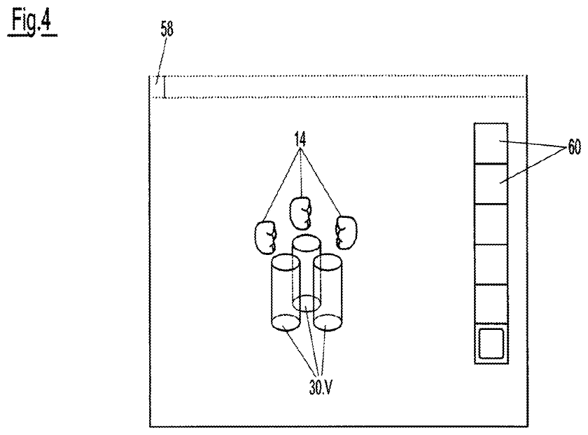

FIG. 4 a positioning of the virtual models on the virtual base bodies with the aid of the program;

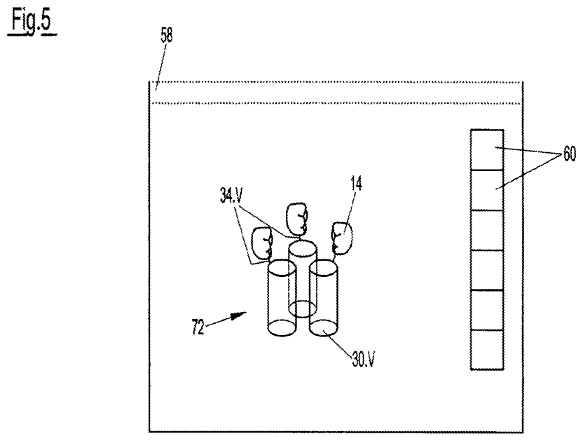

FIG. 5 a production of a virtual structure on the basis of the virtual models with the aid of the program;

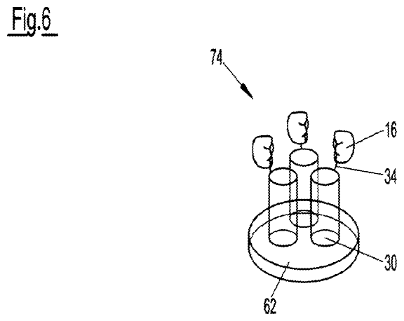

FIG. 6 a physical structure that was produced on the basis of the virtual structure;

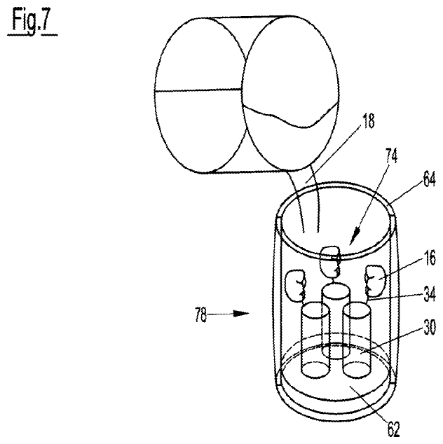

FIG. 7 an embedding of the physical structure in an investment material to produce an embedded body;

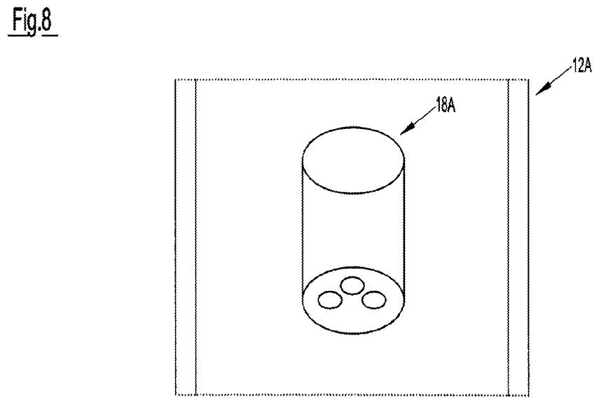

FIG. 8 a burning out of the physical structure from the embedded body to produce a negative mold;

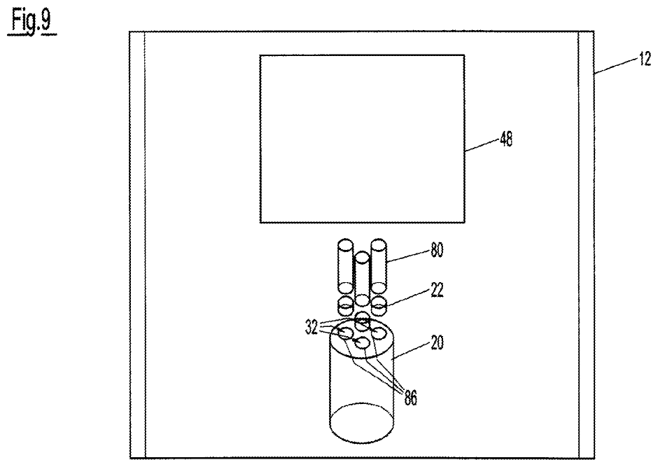

FIG. 9 an insertion of a raw material required for the production of the dental components and of pressing punches into the negative mold;

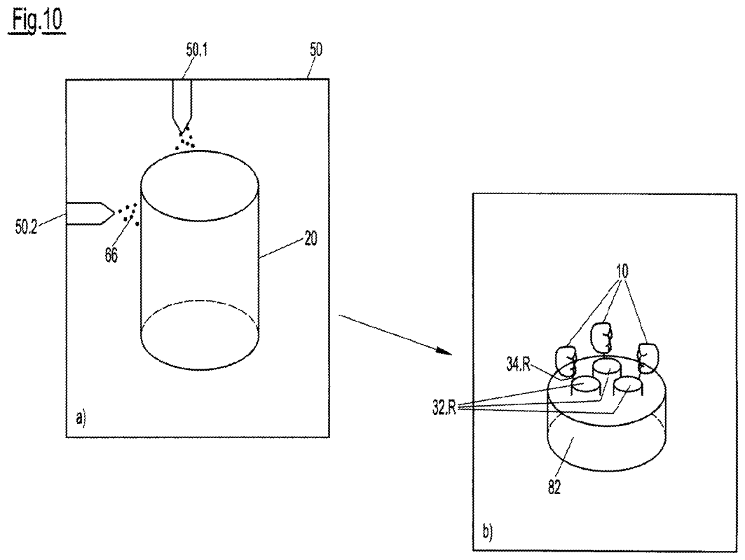

FIG. 10 a deflasking of the dental component with the aid of a deflasking device; and

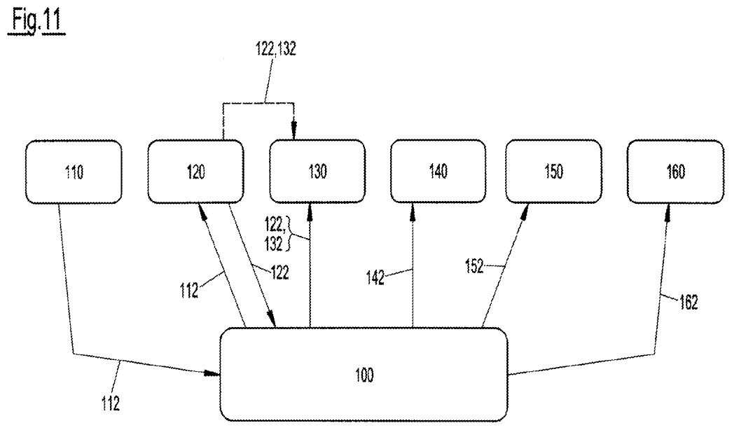

FIG. 11 an embodiment of the system in accordance with the invention.

FIGS. 1 to 10 show the individual steps of an embodiment of the method in accordance with the invention.

A first step of the method in accordance with the invention is shown schematically in FIG. 1. A part of a dentition 42 of a patient is scanned intraorally (indicated by the reference numeral 26) with the aid of a scanning apparatus 40. The part of the dentition 42 has the gums 56 of the dentition, two defect-free teeth 68, and a defective tooth 70 requiring a partial dental prosthesis. It is generally also conceivable that a (negative) impression of the dentition 42 is produced. This impression can then be scanned. However, it is also possible by means of the impression to produce a (positive) physical model of the dentition 42 that is then scanned.

The scan data form the basis for a virtual model 42.V of the scanned part of the dentition 42 (see FIG. 2).

FIGS. 2 to 5 show a graphical user interface 58 of a computer-based program for virtually processing the virtual model 42.V, wherein the graphical user interface 58 has a toolbar 60 by means of which different tools can be selected for preparing and processing a virtual model 14 of a dental component provided for the reconstruction of the defective tooth 70.

In FIG. 2, the virtual model 14 of this partial dental prosthesis is shown that is adapted to the previously prepared virtual dentition 42.V. The virtual dentition 42.V comprises virtual gums 56.V and a virtual, defective tooth 70.V. For example, the virtual dentition 42.V is based on the previously performed intraoral scan 26. With the aid of the computer-based program, the virtual model 14 can be adapted for the defective tooth 70 such that the dentition 42 of the patient can be repaired using a dental component 10 based on the virtual model 14. For example, the virtual model 14 can be automatically or manually taken from a database comprising a plurality of standard models. If necessary, the selected standard model can be adapted to the respective present situation to create a virtual model 14 that is optimized from the point of view of dental technology. In other words: The adaptation can take place automatically, semi-automatically (e.g. a manual adaptation of a basic model or of a standard model), or manually.

In principle, the preparation of a physical model of the virtual model 14 can now be started. However, a plurality of physical models are frequently produced at the same time for the simultaneous manufacture of a plurality of dental components for different patients in order to save costs.

For the embedding of the physical model still described in the following, it is advantageous if it is arranged on a kind of base or on a base body. This can also be planned with the aid of the program. The program can e.g. automatically determine how a plurality of physical models are spatially arranged as advantageously as possible to be able to simultaneously manufacture as many dental components as possible with one process run (this planning can also take place manually or with manual support). For this purpose, a plurality of base bodies are necessary under certain circumstances. In the present example, the program suggests an arrangement of three base bodies (virtual base bodies 30.V) (see FIG. 3). The arrangement of the base bodies 30.V can also be predefined by apparatus framework conditions, e.g. by a configuration of the furnace and/or by a design of a pressing apparatus of the furnace. The virtual base bodies 30.V can be connected to one another by virtual webs (not shown).

In the next step shown in FIG. 4, three virtual models 14 are arranged above the three virtual base bodies 30.V such that the virtual models are indeed disposed close to the virtual base bodies 30.V, but there are still no points of contact.

FIG. 5 represents a planning step in which virtual connection webs 34.V are inserted (automatically, manually, or partly manually) between the virtual base bodies 30.V and the virtual models 14. The connection webs 34.V connect the virtual base bodies 30.V to the virtual models 14. Thus, a virtual structure 72 was created by means of which a physical structure can be produced that forms the basis for preparing a suitable negative mold.

It is understood that the virtual production and processing of the structure 72 can generally take place automatically. However, there is preferably the possibility that an operator can make adjustments as required in all the planning steps.

FIG. 6 shows a physical structure 74 that was produced on the basis of the structure 72 virtually designed in FIGS. 2 to 5. The structure 74 has three physical models 16 that are each a physical copy of the corresponding virtual model 14 and that are each connected to a respective at least one base body 30 via at least one connection web 34. Connection webs can generally also be provided between the models 16 and the base bodies 30. They can subsequently be manually inserted or can already be taken into account in the virtual planning.

The structure 74 can be manufactured on the basis of the previously prepared virtual structure 72 by means of an additive manufacturing process, in particular by means of 3D printing. However, it is also possible to manufacture the structure 74 individual parts thereof in a different manner—in particular by a stripping process, for example by means of milling—and/or to rework the structure 74, in particular manually.

On a production of the structure 74 by means of 3D printing, it is advantageous if all three basic components—models 16, base body 30, and connection webs 34—are produced from the same model material (e.g. a wax-like material and/or plastic). If the three components were only partly produced together or were even produced in individual steps using different methods, the three components thus preferably likewise have the same or at least a similar material. The materials used preferably have a similar melting behavior. The model material is in particular combustible without residue. The material preferably has a melting point, a boiling point, or a sublimation point in a range from above room temperature to 900° C.

A particularly suitable 3D printing process is, for example, stereolithography, in which a light-curing plastic is used.

The structure 74 produced is positioned in a well-defined position and alignment on a base plate 62 and is preferably fixed there. It can also be manufactured (e.g. printed) directly on the base plate 62.

As is shown in FIG. 7, a sleeve 64 is placed onto the base plate 62 so that it surrounds the structure 74 and is, for example, fastened to the plate 62 by means of a plug-in connection. The sleeve 64 forms a cup-like cylinder 78, which is open at one side, with the base plate 62. A suitable investment material 18 is now inserted into the inner space of the cylinder 78. The investment material 18 can be a gypsum-like material and/or phosphate-bonded and/or ethyl silicate-bonded.

After the curing of the investment material 18, the sleeve 64 and the base plate 62 are removed. This can in particular be promoted in that the inner sides of the sleeve 64 and of the base plate 62 are wetted with a separation means prior to the assembly and/or have a corresponding surface coating.

FIG. 8 shows a further step in the production of a dental component. The cured investment material 18 forms an embedded body 18A that is now inserted into a programmable burnout furnace 12A. The embedded body 18A is positioned such that the end face 84 of the cylindrical, cured investment material 18 formed by the base plate 62 faces downwardly.

The process parameters for operating the burnout furnace 12A can be selected automatically, manually, or partly manually on the basis of the virtual model 14, the virtual components 30.V, 34.V (see FIGS. 2 to 5), and/or the total virtual structure 72. The goal is to ensure that the models 16, the connection webs 34, and the base bodies 30 are removed as efficiently and completely as possible by a burning out of the cured investment material 18. For this purpose, suitable process parameters, such as a maximum temperature, a temperature development, and/or a firing duration, are selected to melt the material of the aforementioned components and/or to burn it off without residue without damaging the embedded body. The melted material or the combustion products of the material can flow out or escape from the body 18A.

The process parameters mentioned can naturally also be taken from a database or can be based on empirical values.

A negative mold 20 of the models 16, of the connection webs 34, and of the base bodies 30 results from the process of burning out the models 16, the connection webs 34, and the base bodies 30 from the embedded body 18A. The negative mold 20 thus has channels 32 that are negative impressions of the base bodies 30.

In FIG. 9, it is schematically shown how pellets 22 of a raw material are inserted into the channels 32 of the negative mold 20. Said raw material is preferably divided into portions such that it corresponds to the amount required for the respective dental component 10. The required amount can, for example, be determined from the virtual model 14. The raw material can also be introduced as powder, pellets, or in another form. It is melted in a dental furnace 12 and is pressed into the negative impressions of the models 16 via the negative impressions of the connection webs 34 (=connection passages) on the application of a pressing force to ensure a complete and pore-free filling of the impressions of the models 16. Connection passages between the models 16 and/or the channels 32 facilitate the exchange of melted raw material within different regions of the negative mold 20.

The pressing force is generated by a pressing device 48 associated with the furnace 12 and is transmitted to the raw material by means of pressing punches 80. The pressing force can be generated by an active movement of the punches 80 and/or by a movement of the negative mold 20 relative to the punches 80. The pressing force can be maintained constant or variable in time until the complete curing of the dental component produced. However, it is likewise possible that the pressing force is, for example, only applied until the raw material 22 has fully penetrated into the negative mold of the models 16.

A control device is associated with the dental furnace 12 by which said dental furnace 12 can be controlled. The dental furnace 12 is preferably freely programmable. The process parameters of a firing program—e.g. pressing force and temperature—are determined on the basis of the properties of the virtual model 16 and/or of the virtual structure 72. The type and/or the properties of the raw material used can in this respect be taken into account. It is e.g. possible for the operator to input this information manually and/or to obtain it from a database and to integrate it into the virtual model when planning the latter. The virtual model then therefore not only includes geometric information, but also information that characterizes the material. Based on, for example, the design of the dental components to be produced, the required amount of raw material 22 and the spatial position, the volume and/or the geometry of the negative impressions of the models 16 in the negative mold 20 (the number and position of the base bodies 30 can also be taken into account), a firing program can be automatically suggested by the control device, said firing program being defined by suitable process parameters that can also be a function of time if required. For example, the firing program is calculated or produced (in part) from suitable parameters of the present virtual models 16 or of the virtual structure 72. It is also possible that the firing program is (partly) taken from a program library, wherein parameters of the present virtual models 16 or of the virtual structure 72 are taken into account when selecting the suitable firing program. The suggested and/or produced firing program can be modified by an operator as required. A purely manual definition of the firing program is also conceivable in principle. Provision can also be made that a plurality of firing programs are suggested and/or produced that are e.g. presented to the user by means of a suitable menu. The user then manually selects that program that seems to be the most suitable to him in the respective present case. As a rule, there is not just exactly one program that is optimized with respect to all conceivable aspects (e.g. duration, costs, result, furnace load, . . . ). Due to the manual selection option, the user can now intervene and can, for example, select a longer program that puts less strain on the furnace where possible if there is no time pressure. The user can therefore prioritize certain aspects through his manual selection option and can thus influence the program that is actually used. If necessary, the selected program can be modifiable.

After the curing and cooling of the raw material in the negative mold 20, the investment material 18 is removed. This can take place manually. However, it is more efficient to at least partly automate the deflasking.

For this purpose, a deflasking device 50 is provided (see FIG. 10a) that removes the material 18 by means of compressed air blasting using a solid blasting means (see nozzles 50.1, 50.2) or by means of water blasting. Other stripping processes such as milling and/or combinations of different processes can also be used.

The position of the produced dental components in the mold 20 is known based on the data of the virtual structure 72 and due to the well-defined fixing of the physical structure 74 on the base plate 62. If the mold 20 is now positioned in a known alignment and position in the deflasking device 50, said data can serve as a basis for a control of the deflasking device 50. Said deflasking device 50 is controlled such that the material 18 is efficiently removed without damaging the components. An intervention by an operator nevertheless remains possible, should it be necessary. Provision can also be made that only a rough removal of the material 18 is performed in an automated matter and the final deflasking takes place manually. Larger regions of the body 18A in which no components are included can also be detached, in particular cut off, as whole pieces in a manual, semi-automated, or automated manner.

The type and/or the properties of the investment material 18 can be taken into account in the automated or semi-automated deflasking. For example, corresponding information is input manually or is taken from a database.

Markings and/or mechanical codings can be provided to facilitate the positionally accurate and reproducible positioning of the structure 74 on the base plate 62 (or on a comparable base unit) and/or of the mold 20 in the device 50.

FIG. 10b shows the result of the deflasking. The dental components 10 produced by means of the mold 20 are also connected to the raw material (webs 34.R) that is cured in the passages produced by the webs 34 and that is in turn connected to raw material cured in the channels 32 (see reference letter 32.R). The components 10, 34.R, and 32.R are an at least partial copy of the physical structure 74 (the base bodies 30 are generally not completely reproduced) that is anchored in a base 82 (remainder of the negative mold 20). The dental components 10 can now be detached and reworked as required.

FIG. 11 schematically shows a system in accordance with the invention. The raw data 112 acquired by a raw data acquisition device 110 (e.g. a scanner 40, see FIG. 1) are fed to a control 100 that can be a control and regulation device. It forwards the raw data 112 to a model planning module 120 that is, for example, a program module that is integrated into the control 100 or that runs on a separate processing unit.

A virtual model of the required dental component and/or of a structure including the component is—automatically, semi-automatically, or manually—generated on the basis of the raw data 112 with the aid of the model creation module 120 (see e.g. FIGS. 2 to 5). Corresponding model data 122 are transmitted via the control 100 or directly (see dashed arrow) to a model manufacturing device 130 (e.g. a 3D printer), where a physical model or a physical structure of the virtual model or of the virtual structure is produced (see e.g. FIG. 6). It is also possible that the model data 122 are first converted into operating parameters 132 and/or into a corresponding operating program for the device 130. The parameters or the program 132 can be input by an operator at the device 130 or at the control 100. However, the corresponding parameters or the corresponding program 132 are preferably automatically produced or selected on the basis of the model data 122 and—if necessary—modified by the operator as required.

After the embedding of the physical model or of the physical structure, the embedded body obtained is burned out in a programmable furnace 140 (e.g. a burnout furnace 12A, FIG. 8). The operating parameters 142 required for this purpose and/or a corresponding operating program can be input by an operator at the furnace 140 or at the control 100. However, the corresponding parameters or the corresponding program 142 are preferably automatically produced or selected on the basis of the model data 122 (wherein the type and/or the properties of the model material is/are preferably also taken into account) and—if necessary—modified by the operator as required.

The burnout process provides a negative mold of the physical model or physical structure. The mold is filled with the material of the dental component (see e.g. FIG. 9) and is fired in a programmable dental furnace (e.g. furnace 12)—optionally with a pressing device. The operating parameters 152 required for this purpose and/or a corresponding operating program can be input by an operator at the furnace 150 or at the control 100. However, the corresponding parameters or the corresponding program 162 are preferably automatically produced or selected on the basis of the model data 122 (wherein the type and/or the properties of the raw material is/are preferably also taken into account) and—if necessary—modified by the operator as required.

The component produced in the negative mold now has to be removed from the investment material. For this purpose, a deflasking apparatus 160 is provided (see e.g. the deflasking device 50, FIG. 10). The deflasking can generally take place manually. However, this step is preferably also performed in a completely automated manner or in an at least partly automated manner (e.g. “rough” deflasking in an automated manner, concluding “final deflasking” in a manual manner). The operating parameters 162 required for this purpose and/or a corresponding operating program can be input by an operator at the apparatus 160 or at the control 100. However, the corresponding parameters or the corresponding program 162 are preferably automatically produced or selected on the basis of the model data 122 (wherein the type and/or the properties of the raw material is/are preferably also taken into account) and—if necessary—modified by the operator as required.

A single control 100 was shown by way of example. However, it is also conceivable to provide two or more control units that each control and/or regulate parts of the process or one or more of the functional units 110, 120, 130, 140, 150, 160 described above. The control units can also be connected between a higher-ranking control and the functional units. The data exchange between the control or the control unit(s) and the functional units and/or among the control units themselves and/or among the functional units themselves (shown by way of example at the units 120, 130; if required, the other or some of the other units can also be connected to one another) preferably takes place via a network, e.g. via the Internet and/or via a local network (in a wireless and/or wired manner). Parts of the system can thus be arranged spatially separated from one another to make ideal use of resources.

Any necessary data format conversions or modifications of the data, e.g. a conversion of visualization data records into CAD data records or similar, can be performed at any desired point in the system. The same applies to the automatic or semi-automatic production and/or selection of the model parameters or model data or operating parameters or operating data 122, 132, 142, 152, 162.

The system in accordance with the invention or the corresponding method is based on a use of virtual data that is as efficient as possible to control different apparatus that are required to produce a dental component. Interventions by an operator are minimized, which is accompanied by cost advantages. The linking of the components of the system allows the spatial separation of individual process steps to be able to exploit specific location advantages in each case. For example, the planning of the dental component, that is the virtual preparation of the actual manufacturing steps, can take place at a different location than the actual manufacturing steps.

### REFERENCE NUMERAL LIST

10 dental component
12 dental furnace
12A burnout furnace
14 virtual model
16 physical model
18 investment material
18A embedded body
20 negative mold
22 raw material pellet
26 intraoral scanning
30 physical base body
30.V virtual base body
32 channel
32.R cured raw material in the channel 32
34 physical connection web
34.R web composed of cured raw material
34.V virtual connection web
40 scanning apparatus
42 physical dentition
42.V virtual dentition
48 pressing device
50 deflasking device
50.1, 50.2 nozzle
56 physical gums
56.V virtual gums
58 graphical user interface
60 toolbar
62 base plate
64 sleeve
68 healthy tooth
70 damaged tooth
70.V virtual damaged tooth
72 virtual structure
74 physical structure
78 cylinder
80 pressing punch
82 base
110 raw data acquisition device
112 raw data
120 model planning module
122 model data
130 model manufacturing device
140, 150 programmable furnace
132, 142, 152, 162 operating parameters, operating program
160 deflasking apparatus

1.-23. (canceled)

24. A method of manufacturing a dental component by means of a dental furnace, comprising the following steps:
(i) preparing a virtual model of the dental component;
(ii) automatically selecting one, two or more programs and/or automatically preparing one, two or more programs and/or preparing one, two or more suggestions for a program for operating the dental furnace on the basis of the virtual model of the dental component;
(iii) producing a model of the dental component;
(iv) embedding the model in an investment material;
(v) removing the model from the investment material to obtain a negative mold of the model;
(vi) inserting a raw material required for manufacturing the dental component into the negative mold; and
(vii) producing the dental component in the negative mold in the dental furnace on the basis of the selected, prepared, or suggested program.

25. The method in accordance with claim 24, wherein step (ii) comprises automatically selecting at least two programs and/or automatically preparing at least two programs and/or preparing at least two suggestions for a program for operating the dental furnace on the basis of the virtual model of the dental component, with a user manually selecting one of the at least two programs so that it is used in step.

26. The method in accordance with claim 24, wherein at least one process parameter for removing the model from the investment material is automatically selected and/or generated and/or suggested on the basis of the virtual model of the dental component.

27. The method in accordance with claim 24, wherein the insertion of the raw material into the negative mold and/or the production of the dental component takes/take place on the application of a pressing force, and/or takes/take place in a temperature range from 100° C. to 1200° C.

28. The method in accordance with claim 24, wherein the program for operating the dental furnace comprises at least one parameter that represents a firing temperature, a firing duration, a temporal progression of the firing temperature, a pressing force, a temporal progression of the pressing force, a cooling temperature, a cooling duration, and/or a temporal progression of the cooling temperature.

29. The method in accordance with claim 26, wherein the at least one parameter and/or the at least one process parameter is/are determined on the basis of the virtual model and/or is/are taken from a database.

30. The method in accordance with claim 28, wherein the at least one parameter and/or the at least one process parameter is/are determined on the basis of the virtual model and/or is/are taken from a database.

31. The method in accordance with claim 24, wherein at least a portion of data required for the preparation of the virtual model is acquired by intraorally scanning a dentition of a patient or a part thereof; and/or in that at least a portion of data required for the preparation of the virtual model is acquired by scanning a negative impression of a dentition of a patient or a part thereof; and/or in that at least a portion of data required for the preparation of the virtual model is taken from a database.

32. The method in accordance with claim 24, wherein the model of the dental component is additively manufactured from a model material on the basis of the virtual model of the dental component.

33. The method in accordance with claim 24, wherein the model is connected to at least one base body.

34. The method in accordance with claim 33, wherein the base body and—if present—a connection passage or connection web connecting the base body and the model are integrally produced with the model by means of the additive manufacturing process; or wherein the model is fastened to the base body before the embedding.

35. The method in accordance with claim 24, wherein a first and at least a second dental component are simultaneously manufactured, with a first and a second model being jointly embedded in the investment material, and with their spatial arrangement in the investment material—and, if provided, their additive manufacturing—being automatically planned and/or suggested on the basis of the virtual model of the first and second dental components.

36. The method in accordance with claim 35, wherein the first and second models or the further models are additively manufactured together.

37. The method in accordance with claim 24, wherein, after the step of the production, the dental component is deflasked in an at least partly automated manner by removing the negative mold on the basis of a virtual model of the dental component.

38. A system for manufacturing a dental component comprising:
a programmable dental furnace;
a control device that is configured and adapted to automatically select at least one program for operating the dental furnace and/or to automatically prepare at least one such program and/or to automatically suggest at least one such program on the basis of a virtual model of the dental component, in particular with the control device being configured and adapted to directly or indirectly control and/or regulate the dental furnace.

39. The system in accordance with claim 38, wherein the system additionally comprises a raw data acquisition device for intraorally scanning a dentition of a patient or a part thereof and/or for scanning a negative impression of a dentition of a patient or a part thereof and/or for scanning a model of the dental component.

40. The system in accordance with claim 38, wherein the control device is configured and adapted to receive the virtual model and/or to prepare the virtual model on the basis of data of at least one scan.

41. The system in accordance with claim 38, wherein the system additionally comprises a model manufacturing apparatus for the additive manufacturing of the model on the basis of the virtual model.

42. The system in accordance with claim 38, wherein the system additionally comprises a programmable furnace for removing the model from the investment material, with the furnace being connectable or connected to the control device to receive control data from the control device.

43. The system in accordance with claim 38, wherein the dental furnace has a pressing device by means of which the raw material can be inserted into the negative mold on the application of a pressing force and/or by means of which the dental component can be produced or fired on the application of a pressing force.

44. The system in accordance with claim 38, wherein the system additionally comprises a deflasking device for an at least partly automated removal of the dental component from the negative mold on the basis of a virtual model, with the deflasking device being connectable or connected to the control device to receive control data from the control device.

45. The system in accordance with claim 38, wherein the raw data acquisition device and/or the model manufacturing apparatus and/or the programmable furnace and/or the dental furnace and/or the deflasking device has/have a control unit that is separate from the control device and that is connectable and/or connected to the control device.
